(19) United States
(12) Patent Application Publication
(10) Pub. No.: US 2009/0150973 A1
(43) Pub. Date: Jun. 11, 2009

(54) ACCESS CONTROL METHOD AND SYSTEM FOR MULTIPLE ACCESSING ENTITIES

(76) Inventors: Geon Woo KIM, Daejeon (KR); Jong Wook HAN, Daejeon (KR); Kyo Il CHUNG, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/209,316

(22) Filed: Sep. 12, 2008

(30) Foreign Application Priority Data
Dec. 6, 2007 (KR) 10-2007-0126320

(51) Int. Cl. H04L 9/00

(52) U.S. Cl. 726/1

(57) ABSTRACT

An access control method and system for multiple accessing entities are provided. The access control method includes generating a plurality of integrated identifiers (IDs) respectively corresponding a plurality of individual ID groups, each having the individual IDs of a number of entities; if multiple accessing entities issue a request for access to a service, extracting an integrated ID corresponding to a list of the individual IDs of the multiple accessing entities; and searching for an access control policy corresponding to the extracted integrated ID and the ID of the service and performing access control on the multiple accessing entities according to the identified access control policy. Therefore, it is possible to efficiently control the access of multiple accessing entities to a service.

This application claims the benefit of Korean Application No. 10-2007-0126320, filed Dec. 6, 2007 in the Korean Intellectual Property Office, the disclosure of which is incorporated herein by reference.

### BACKGROUND OF THE INVENTION

1. Field of the Invention

The present invention relates to an access control method and system for multiple accessing entities, which can efficiently control the access of multiple accessing entities to services.

The present invention was supported by the IT R&D program of Ministry of Information and Communication(MIC) and Institute for Information Technology Advancement (IITA)[Project No.: 2006-S-067-02, Project Title: The Development of Security Technology based on Device Authentication for Ubiquitous Home Network]

2. Description of the Related Art

An access control policy of a typical access control system defines an accessing entity which attempts to access another entity and an accessed entity which allows or blocks the access of an accessing entity thereto. For example, when a user attempts to access a file system, the user is an accessing entity, and the file system is an accessed entity. In this case, access control may be performed by searching for an access control policy regarding the user and either allowing or blocking the access of the user to the file system.

However, in an environment for providing services such as a home network services or ubiquitous services, not only a user who attempts to access a service but also a device that the user uses to access the service may both be recognized as accessing entities. In this case, it is possible to provide a variety of efficient and secure access control policies by treating the user and the device as a single integrated accessing entity.

### SUMMARY OF THE INVENTION

The present invention provides an access control method and system for multiple accessing entities, in which access control is performed by treating multiple accessing entities that attempt to access a service as a single integrated accessing entity.

According to an aspect of the present invention, there is provided an access control method for multiple accessing entities, the access control method including generating a plurality of integrated identifiers (IDs) respectively corresponding a plurality of individual ID groups, each having the individual IDs of a number of entities; if multiple accessing entities issue a request for access to a service, extracting an integrated ID corresponding to a list of the individual IDs of the multiple accessing entities; and searching for an access control policy corresponding to the extracted integrated ID and the ID of the service and performing access control on the multiple accessing entities according to the identified access control policy.

According to another aspect of the present invention, there is provided an access control system for multiple accessing entities, the access control system including an integrated ID database (DB) configured to store a plurality of integrated identifiers (IDs) respectively corresponding a plurality of individual ID groups, each having the individual IDs of a number of entities; and an access control unit configured to extract an integrated ID corresponding to a list of the individual IDs of multiple accessing entities upon receiving a request for access to a service from the multiple accessing entities, to search for an access control policy corresponding to the extracted integrated ID and the ID of the service and to perform access control on the multiple accessing entities according to the identified access control policy.

According to another aspect of the present invention, there is provided a computer-readable recording medium having recorded thereon a computer program for executing an access control method for multiple accessing entities, the access control method including: generating a plurality of integrated IDs respectively corresponding a plurality of individual ID groups, each having the individual IDs of a number of entities; if multiple accessing entities issue a request for access to a service, extracting an integrated ID corresponding to a list of the individual IDs of the multiple accessing entities; and searching for an access control policy corresponding to the extracted integrated ID and the ID of the service and performing access control on the multiple accessing entities according to the identified access control policy.

### BRIEF DESCRIPTION OF THE DRAWINGS

The above and other features and advantages of the present invention will become more apparent by describing in detail preferred embodiments thereof with reference to the attached drawings in which:

FIG. 1 illustrates a block diagram of an access control system according to an embodiment of the present invention;

FIG. 2 illustrates a block diagram of an integrated identifier (ID) database (DB) illustrated in FIG. 1; and

FIG. 3 illustrates a flowchart of an access control method according to an embodiment of the present invention.

### DETAILED DESCRIPTION OF THE INVENTION

The present invention will hereinafter be described in detail with reference to the accompanying drawings in which exemplary embodiments of the invention are shown.

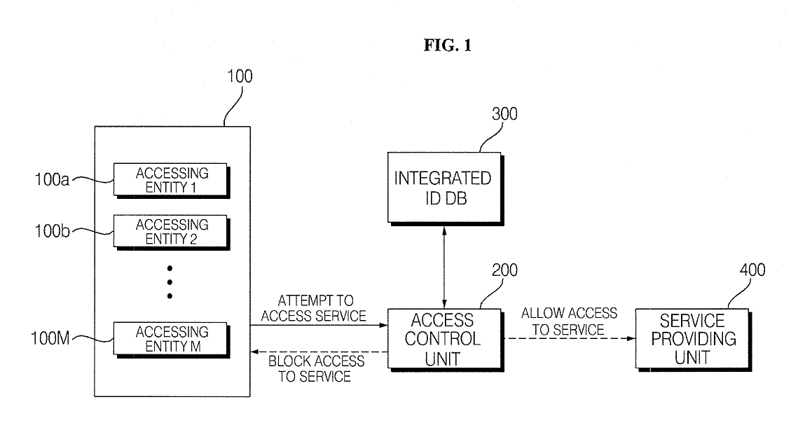

FIG. 1 illustrates a block diagram of an access control system according to an embodiment of the present invention. Referring to FIG. 1, the access control system includes a plurality of accessing entities 100a through 100n, an access control unit 200, an integrated identifier (ID) database (DB) 300, and a service providing unit 400. The accessing entities 100a through 100n will hereinafter be collectively referred to as the multiple accessing entities 100.

The multiple accessing entities 100 may include nearly all types of accessing entities that can exist in an existing service providing structure. For example, if the access control system is a home network system, the multiple accessing entities 100 may include a user and a home device that the user uses to access a home network service.

When the multiple accessing entities 100 access a service, the access control unit 200 searches the integrated ID DB 300 for an integrated ID corresponding to the multiple accessing entities 100. Thereafter, the access control unit 200 searches for an access control policy corresponding to the identified integrated ID and the ID of a desired service that the multiple accessing entities 100 wish to access. Thereafter, the access control unit 200 performs access control according to the identified access control policy by either allowing or blocking the access of the multiple accessing entities 100 to the service providing unit 400.

The integrated ID DB 300 maps the individual IDs of the multiple accessing entities 100 to a number of integrated IDs. The service providing unit 400 provides services to a number of multiple accessing entities 100 that are allowed to access the service providing unit 400 by the access control unit 200.

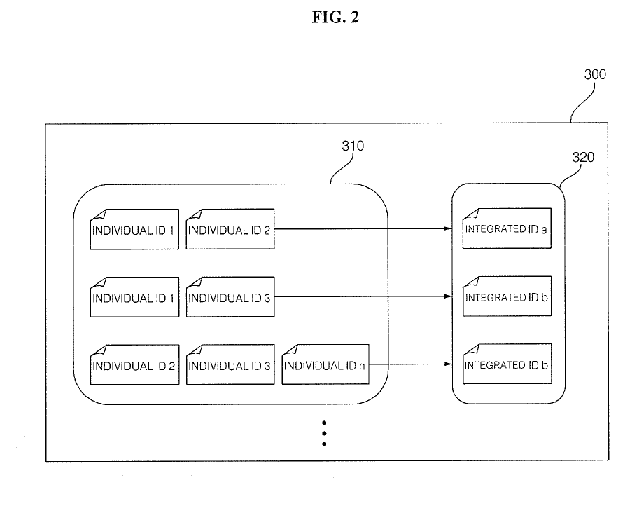

FIG. 2 illustrates a block diagram of the integrated ID DB 300 illustrated in FIG. 1. Referring to FIG. 2, the integrated ID DB 300 stores a plurality of groups of individual IDs 310 and a plurality of integrated IDs 320 respectively corresponding to the individual ID groups 310. For example, an individual ID group including individual IDs 1 and 2 respectively corresponding to accessing entities 1 and 2 corresponds to integrated ID a, an individual ID group including individual IDs 1 and 3 respectively corresponding to accessing entities 1 and 3 corresponds to integrated ID b, and an individual ID group including individual IDs 2, 3 and n respectively corresponding to accessing entities 2, 3 and n corresponds to integrated ID c.

The correspondence between the individual ID groups 410 and the integrated IDs 420 may be determined by a service manager or may be determined using a predetermined ID generation method.

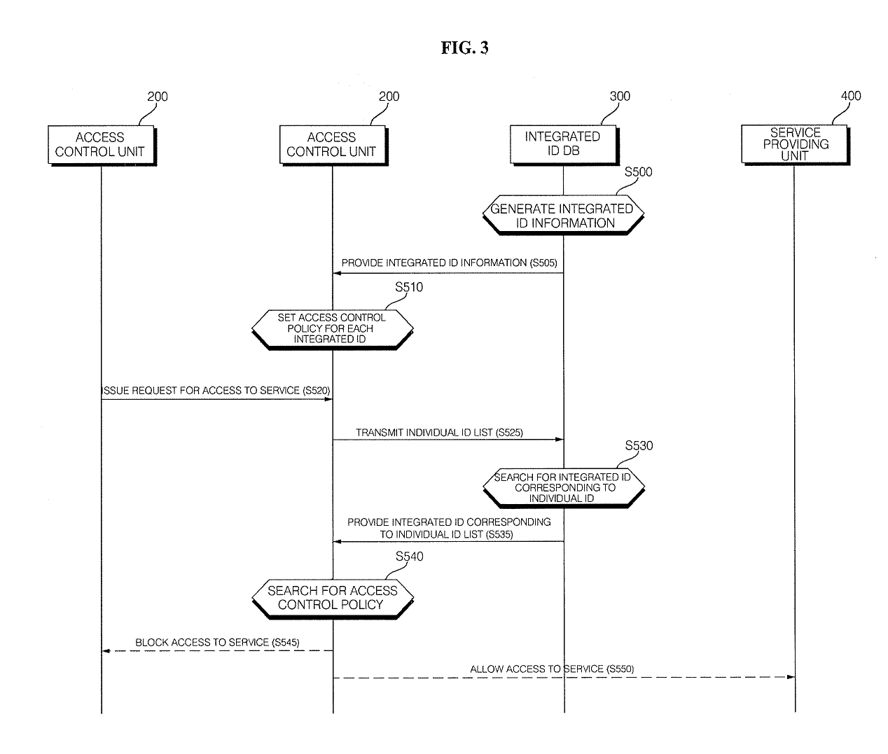

FIG. 3 illustrates a flowchart of an access control method according to an embodiment of the present invention. Referring to FIG. 3, a plurality of integrated IDs respectively corresponding to a plurality of individual ID groups, each individual ID group including the individual IDs of a number of entities, are generated, and the integrated IDs are stored in the integrated ID DB 300 (S500). The access control unit 200 receives the integrated IDs from the integrated ID DB 300 and sets an access control policy for each of the integrated IDs (S510). The access control policy may be an access control policy for multiple accessing entities or an access control policy for a single accessing entity.

Thereafter, if the multiple accessing entities 100 issue a request for access to a predetermined service by using a list of the individual IDs of the multiple accessing entities 100 and the ID of the predetermined service (S520), the access control unit 200 search the integrated ID DB 300 for an integrated ID corresponding to the individual IDs of the multiple accessing entities 100 (S530 and S535).

Thereafter, the access control unit 200 searches for an access control policy corresponding to the integrated ID corresponding to the individual IDs of the multiple accessing entities 100 and the ID of the predetermined service (S540). Thereafter, the access control unit 200 may perform access control according to the identified service policy by either blocking the access of the multiple accessing entities 100 to the predetermined service (S545) or allowing the access of the multiple accessing entities 100 to the predetermined service (S550).

In this manner, it is possible to efficiently perform access control by treating multiple accessing entities as a single accessing entity using integrated ID information.

The present invention can be realized as computer-readable code written on a computer-readable recording medium. The computer-readable recording medium may be any type of recording device in which data is stored in a computer-readable manner. Examples of the computer-readable recording medium include a ROM, a RAM, a CD-ROM, a magnetic tape, a floppy disc, an optical data storage, and a carrier wave (e.g., data transmission through the Internet). The computer-readable recording medium can be distributed over a plurality of computer systems connected to a network so that computer-readable code is written thereto and executed therefrom in a decentralized manner. Functional programs, code, and code segments needed for realizing the present invention can be easily construed by one of ordinary skill in the art.

As described above, according to the present invention, when multiple accessing entities attempt to access a service, it is possible to efficiently perform access control by treating the multiple accessing entities as a single accessing entity using integrated ID information. Therefore, it is possible to effectively secure and protect various service resources in a ubiquitous computing environment or a home network service environment.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An access control method for multiple accessing entities, the access control method comprising:
generating a plurality of integrated identifiers (IDs) respectively corresponding a plurality of individual ID groups, each comprising the individual IDs of a number of entities;
if multiple accessing entities issue a request for access to a service, extracting an integrated ID corresponding to a list of the individual IDs of the multiple accessing entities; and
searching for an access control policy corresponding to the extracted integrated ID and the ID of the service and performing access control on the multiple accessing entities according to the identified access control policy.

2. The access control method of claim 1, further comprising setting an access control policy for each of the integrated IDs.

3. The access control method of claim 1, wherein the performing access control, comprises, if the identified access control policy allows the access of the multiple accessing entities to the service, controlling the multiple accessing entities to access the service.

4. The access control method of claim 1, wherein the performing access control, comprises, if the identified access control policy blocks the access of the multiple accessing entities to the service, controlling the multiple accessing entities not to access the service.

5. The access control method of claim 1, wherein the identified access policy comprises an access control policy for a single accessing entity.

6. The access control method of claim 1, wherein the multiple accessing entities issue a request for access to the service by using a message comprising the list of the individual IDs of the multiple accessing entities and the ID of the service.

7. An access control system for multiple accessing entities, the access control system comprising:
an integrated ID database (DB) configured to store a plurality of integrated identifiers (IDs) respectively corresponding a plurality of individual ID groups, each comprising the individual IDs of a number of entities; and
an access control unit configured to extract an integrated ID corresponding to a list of the individual IDs of multiple accessing entities upon receiving a request for access to a service from the multiple accessing entities, to search for an access control policy corresponding to the extracted integrated ID and the ID of the service and to perform access control on the multiple accessing entities according to the identified access control policy.

8. The access control system of claim 7, wherein the access control unit sets an access control policy for each of the integrated IDs.

9. The access control system of claim 7, further comprising a service providing unit which provides the service to the multiple accessing entities if the identified access control policy allows the access of the multiple accessing entities to the service.

10. The access control system of claim 7, wherein, if the identified access control policy allows the access of the multiple accessing entities to the service, the access control unit controls the multiple accessing entities to access the service.

11. The access control system of claim 7, wherein, if the identified access control policy blocks the access of the multiple accessing entities to the service, the access control unit controls the multiple accessing entities not to access the service.

12. The access control system of claim 7, wherein the identified access policy comprises an access control policy for a single accessing entity.

13. The access control system of claim 7, wherein the multiple accessing entities issue a request for access to the service by using a message comprising the list of the individual IDs of the multiple accessing entities and the ID of the service.

14. A computer-readable recording medium having recorded thereon a computer program for executing an access control method for multiple accessing entities, the access control method comprising:
generating a plurality of integrated IDs respectively corresponding a plurality of individual ID groups, each comprising the individual IDs of a number of entities;
if multiple accessing entities issue a request for access to a service, extracting an integrated ID corresponding to a list of the individual IDs of the multiple accessing entities; and
searching for an access control policy corresponding to the extracted integrated ID and the ID of the service and performing access control on the multiple accessing entities according to the identified access control policy.
